(19) United States
(12) Patent Application Publication
(10) Pub. No.: US 2024/0094783 A1
(43) Pub. Date: Mar. 21, 2024

(54) SHAPE-MEMORY ALLOYS TO SELECTIVELY SECURE COMPONENTS

(71) Applicant: HEWLETT-PACKARD DEVELOPMENT COMPANY, L.P., Spring, TX (US)

(72) Inventors: Yu-Wen LIN, Taipei City (TW); Chia-Ming TSAI, Taipei City (TW); Shih-Jen CHOU, Taipei City (TW); John Joseph GRODEN, Spring, TX (US)

(21) Appl. No.: 17/945,807

(22) Filed: Sep. 15, 2022

(51) Int. Cl. G06F 1/16

(52) U.S. Cl. CPC G06F 1/1681; G06F 1/1679

(57) ABSTRACT

An example computing device includes a first housing portion, a second housing portion moveably connected to the first housing portion, a link to selectively secure the second housing portion to the first housing portion to inhibit movement of the second housing portion relative to the first housing portion, and a shape-memory alloy element to release the link to allow the second housing portion to move relative to the first housing portion.

### BACKGROUND

Computing devices often have movable components. A notebook computer, for example, typically includes a display panel that pivots with respect to a main body. This provides for portability in that the display panel can be closed, and it also provides for the adjustment of viewing angle when the display panel is in use. Other types of computing devices, particularly portable computing devices, may have other types of movable components.

### BRIEF DESCRIPTION OF THE DRAWINGS

FIG. 1 is a block diagram of an example computing device with a shape-memory alloy element to release a link to allow relative motion of housing portions of the computing device.

FIG. 2A is a diagram of an example apparatus with a shape-memory alloy element to unlock a lock to allow relative motion of housing portions held by the lock, in which the locked position is shown.

FIG. 2B is a diagram of the example apparatus of FIG. 2A showing the unlocked position.

FIG. 3A is a diagram of an example apparatus with a shape-memory alloy element to unlock a magnetic lock to allow relative motion of housing portions held by the magnetic lock, in which the locked position is shown.

FIG. 3B is a diagram of the example apparatus of FIG. 3A showing the unlocked position.

FIG. 4 is a diagram of an example circuit with a shape-memory alloy element and a sensor to trigger the shape-memory alloy element to release a link or lock.

FIG. 5 is a perspective view of an example computing device with a shape-memory alloy element to release a link to allow relative motion of housing portions of the computing device.

FIG. 6A is a side view of the example computing device of FIG. 5 shown when closed.

FIG. 6B is a side view of the example computing device of FIG. 5 shown when partially opened.

FIG. 6C is a side view of the example computing device of FIG. 5 shown with the shape-memory alloy element having released the link to allow relative motion of housing portions of the computing device.

FIG. 7 is a side view of an example computing device with a switch to activate a shape-memory alloy element.

FIG. 8 is a perspective view of an example computing device with a user-actuatable button to activate a shape-memory alloy element.

### DETAILED DESCRIPTION

In a computing device with movable components, such as housing portions that are pivot connected, such movement may be locked at a specific position or positions. Locking may use a magnet, latch, clip, or other link or lock mechanism to temporarily secure a movable component to a relatively stationary component. The computing device may be designed so that user action, such as the manual application of force, may overcome the locking effect to cause a component to move.

User application of force may be imprecise and may cause undesired movement of a component. For example, a manually moved component may impact another component, which may cause damage or may cause the user to view the computing device as poorly designed.

As discussed herein, a shape-memory alloy allows selective linking or locking of housing portions or other components of computing device, such as a notebook computer. For example, the shape-memory alloy may be controlled to disengage a link or lock that holds a screen panel to a relatively stationary part of the computing device, so that the screen panel may be freely rotated when desired. Direct application of user-applied force may be avoided, which may reduce the likelihood of damage and may improve the user's experience with the computing device.

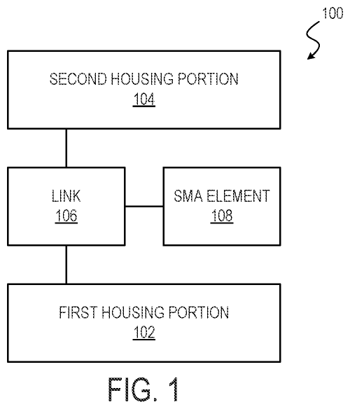

FIG. 1 shows an example computing device 100 with a shape-memory alloy element to release a link to allow relative motion of housing portions of the computing device. The computing device may be a notebook computer, tablet computer, smartphone, or similar computing device that includes a movable housing portion.

The computing device 100 includes a first housing portion 102, a second housing portion 104, a link 106, and a shape-memory alloy (SMA) element 108. In other examples, instead of or in addition to the housing portions 102, 104, other components of the computing device 100 are selectively held by the link 106 with the same principles discussed below applying.

The first and second housing portions 102, 104 may each include a body, such as a plastic or metal structure, that holds or contains components of the computing device, such as a processor, memory, display device, network interface, antenna, keyboard, trackpad, battery, power supply, cooling system, fan, and so on.

The second housing portion 104 is moveably connected to the first housing portion 102. In various examples, the first and second housing portions 102, 104 are connected by a hinge, such that the second housing portion 104 is pivotable relative to the first housing portion 102. Other suitable types of connections include pin connections, slider connections, swivel connections, and linkages.

The link 106 selectively secures the second housing portion 104 to the first housing portion 102 to inhibit movement of the second housing portion 104 relative to the first housing portion 102. The link 106 may include a magnet, a mechanical latch, a clip, a clasp, a hook, or similar securing structure. The link 106 may be referred to as a lock.

The link 106 may secure the second housing portion 104 relative to the first housing portion 102 with a force that may be manually overcome by a user of the computing device 100. For example, when the link 104 includes a magnet, a magnetic attractive force may be overcome by manual application of force by the user. That is to say, the link 104 may be a relatively weak link, sufficient to prevent unintended motion of the second housing portion 104. In various examples, the link 106 includes a pair of magnetic elements, such a permanent magnet positioned at one housing portion 102, 104 and a permanent magnet or ferromagnetic material positioned at the other housing portion 102, 104. In other examples, the link 106 may be a relatively strong link that is not readily manually overcome, such as a mechanical latch.

The shape-memory alloy element 108 releases the link 106 to allow the second housing portion 104 to move relative to the first housing portion 102. To do this, the shape-memory alloy element 108 may actuate or move a component of the link 106. For example, when the link 106 includes a pair of magnetic elements, the shape-memory alloy element 108 may move one of the magnetic elements relative to the other magnetic element to reduce the magnetic attractive force. When the link 106 includes a mechanical latch or similar mechanism, the shape-memory alloy element 108 may move a component of the latch into an unlatched position or orientation.

The shape-memory alloy element 108 has a pre-deformed shape and a deformed shape. The shape-memory alloy element 108 normally takes its deformed shape. When the shape-memory alloy element 108 is heated, it takes its pre-deformed (or “remembered”) shape.

The shape-memory alloy element 108 may have a deformed shape that urges the link 106 to secure the second housing portion 104 to inhibit movement of the second housing portion 104, and a pre-deformed (or “remembered”) shape that releases the link 106 when the shape-memory alloy element 108 is heated. For example, the shape-memory alloy element 108 may include a wire that has a straight deformed shape and a bent pre-deformed shape, where the bend is shaped to shorten the effective length of the shape-memory alloy element to release the link 106.

In an example operation, electrical current may be applied to the shape-memory alloy element 108 by a power supply of the computing device to provide heat to trigger the pre-deformed shape. The shape-memory alloy element 108 may be allowed to cool passively with the environment, e.g., via passive heat transfer, to return to its deformed shape.

Any suitable shape-memory alloy may be used for particular implementations of the examples discussed herein. A particular alloy may be chosen based on the force required to actuate the link 106, the amount of heating that is able to be provided to the shape-memory alloy element 108, and the amount of incidental heating permitted for components near the shape-memory alloy element 108.

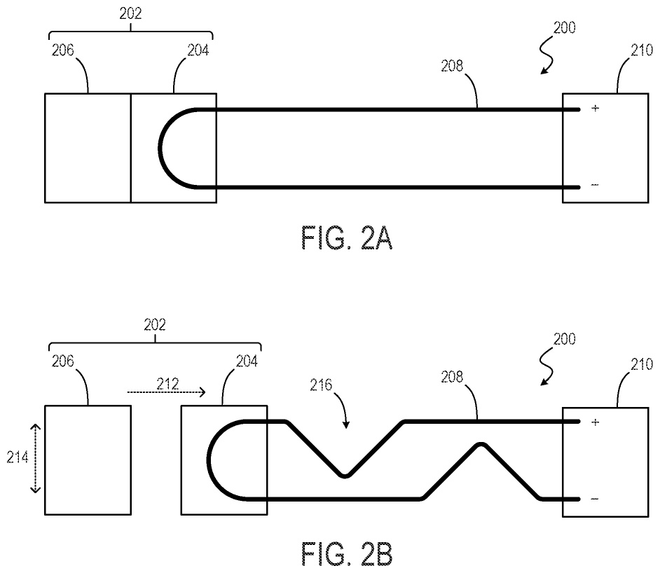

FIGS. 2A and 2B show an example apparatus 200 with a shape-memory alloy element to unlock a lock to allow relative motion of housing portions or other components held by the lock. The apparatus 200 may be used to selectively secure movement of housing portions of a computing device, such as the computing device 100 of FIG. 1. For example, the apparatus 200 may be used as the link 106 and shape-memory alloy 108 of FIG. 1. FIG. 2A shows the locked position. FIG. 2B shows the unlocked position.

The apparatus 200 includes a lock 202 (or link) that includes first lock component 204 and a second lock component 206. The first lock component 204 is moveable. The second lock component 206 is formed with or is attachable to a second housing portion (e.g., portion 104 of FIG. 1) of a computing device, where such second housing portion is moveably connected to a first housing portion (e.g., portion 102 of FIG. 1). In other examples, components other than housing portions of a computing device may be controlled by the lock 202.

The apparatus 200 includes a shape-memory alloy wire 208 connected to the lock 202. In this example, the shape-memory alloy wire 208 is attached to the first lock component 204. The shape-memory alloy wire 208 may also be attached to a support 210, which may be formed from or attachable to a first housing portion (e.g., portion 102 of FIG. 1). The shape-memory alloy wire 208 may have a loop-like shape with one end secured to the support 210 and the other end attached to the first lock component 204 to move the first lock component 204.

The second lock component 206 of the lock 202 and the second housing portion that carries it are moveable with respect to the relative stationary assembly of the support 210, shape-memory alloy wire 208, first lock component 204, and the first housing portion that carries these components.

When locked, the lock 202 selectively holds stationary the second lock component 206 relative to the assembly of the support 210, shape-memory alloy wire 208, and first lock component 204. The second lock component 206 engages the first lock component 204 via mechanical, magnetic, or other force. Accordingly, the second housing portion at the second lock component 206 is held stationary relative to the first housing portion at the support 210.

When the lock 202 is unlocked, the second housing portion 206 is free to move relative to the assembly of the support 210, shape-memory alloy wire 208, and first lock component 204. The second lock component 206 disengages from the first lock component 204 via reduction or removal of the mechanical, magnetic, or other force. Accordingly, the second housing portion at the second lock component 206 is free to move relative to the first housing portion at the support 210.

The shape-memory alloy wire 208 has a deformed shape, as shown in FIG. 2A, to lock the lock 202 by engaging the first lock component 204 with the second lock component 206. The shape-memory alloy wire 208 normally takes its deformed shape, i.e., when current is not applied to the shape-memory alloy wire 208.

The shape-memory alloy wire 208 has a pre-deformed shape, as shown in FIG. 2B, to unlock the lock 202 by disengaging the first lock component 204 from the second lock component 206, as indicated by arrow 212. In this example, the overall size of the shape-memory alloy wire 208 contracts to provide a shorter distance between the first lock component 204 and the support 210 to disengage the lock components 206, 208.

The shape-memory alloy wire 208 adopts its pre-deformed shape when current is applied to the shape-memory alloy wire 208 to heat the shape-memory alloy wire 208. When the lock 202 is thus unlocked, the second lock component 206 and any anything attached to it, such as the second housing portion (e.g., portion 104 of FIG. 1), is free to move, as indicated by arrow 214, relative to the stationary assembly of the shape-memory alloy wire 208, the first lock component 204, the support 210, and anything attached to the support 210, such as a first housing portion (e.g., portion 102 of FIG. 1).

In this example, the shape-memory alloy wire 208 has a loop or circuit-like shape to facilitate application of a voltage at respective ends of the wire (indicated as + and − in the figures). This causes current to flow through the shape-memory alloy wire 208 to heat it and trigger its pre-deformed shape.

The pre-deformed shape of the wire 208 may include a bend 216. In this example, two bends are provided, one at each leg of the loop. This facilitates even contraction of the shape-memory alloy wire 208 in the direction of arrow 212 with increased force compared to a single non-looped wire. Any suitable number, position, and shape of bends may be used to define pre-deformed and deformed shapes. The curvature (e.g., bend, etc.) of the shape-memory alloy wire 208 that controls the unlocking may reside in a plane (e.g., the plane of the figure) to facilitate installation in relatively planar or flat spaces.

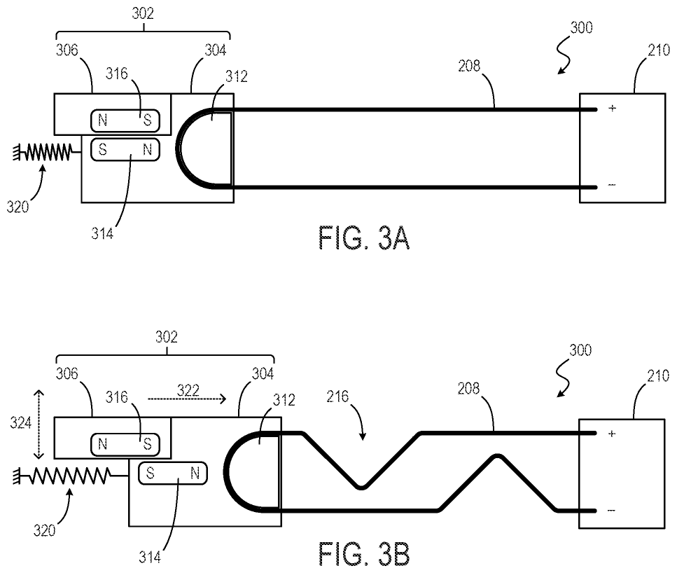

FIGS. 3A and 3B show an example apparatus 300 with a shape-memory alloy element to unlock a magnetic lock to allow relative motion of housing portions or other components held by the magnetic lock. The apparatus 300 may be used to selectively secure movement of housing portions of a computing device, such as the computing device 100 of FIG. 1. For example, the apparatus 300 may be used as the link 106 and shape-memory alloy 108 of FIG. 1. FIG. 3A shows the locked position. FIG. 3B shows the unlocked position. The description above for FIGS. 2A and 2B may be referenced for detail not repeated here.

The apparatus 300 includes a magnetic lock 302 (or link) that includes first lock component 304 and a second lock component 306. The second lock component 306 is formed from or attachable to a second housing portion (e.g., portion 104 of FIG. 1) of a computing device, where second housing portion is moveably connected to a first housing portion (e.g., portion 102 of FIG. 1). In other examples, components other than housing portions of a computing device may be controlled by the lock 302.

The apparatus 300 includes a shape-memory alloy wire 208 connected to the magnetic lock 302. In this example, the shape-memory alloy wire 208 is connected by a securement structure, such as a boss 312, to the first lock component 304. The boss 312 may be a raised portion of the first lock component 304 around which a portion of the wire 208 may be wrapped. Another example securement structure is a groove that fits the shape-memory alloy wire 208. The shape-memory alloy wire 208 may also be attached to a support 210, which may be formed from or attachable to a first housing portion (e.g., portion 102 of FIG. 1).

The second lock component 306 of the magnetic lock 302 and the second housing portion are moveable with respect to the relative stationary assembly of the support 210, shape-memory alloy wire 208, first lock component 304, and first housing portion.

The first lock component 304 may include a first magnetic element 314 that is thus attached to the first housing portion. The second lock component 306 may include a second magnetic element 316 that is thus attached to the relatively movable second housing portion. In various examples, the first magnetic element 314, the second magnetic element 316, or both include a permanent magnet. In various examples, one of the magnetic elements 314, 316 is a permanent magnet and the other is a magnetically responsive material, such as ferromagnetic metal. In the example shown, both magnetic elements 314, 316 are permanent magnets and their poles are oriented oppositely.

The first magnetic element 314 and the second magnetic element 316 are arranged in an attractive relative positioning to hold stationary the second housing portion relative to the first housing portion. This occurs when the shape-memory alloy wire 208 is in its deformed shape, as shown in FIG. 3A. In this example, the north pole of the first magnetic element 314 is adjacent to the south pole of the second magnetic element 316, and the south pole of the first magnetic element 314 is adjacent to the north pole of the second magnetic element 316. The resulting magnetic attractive force locks the second lock component 306 to the first lock component 304 and thus locks the second housing portion to the first housing portion.

The shape-memory alloy wire 208 selectively moves the first magnetic element 314 away from the attractive relative positioning when current is applied to the shape-memory alloy wire 208, as shown in FIG. 3B. In this example, the shape-memory alloy wire 208 selectively moves the first magnetic element 314 into a repulsive relative positioning to the second magnetic element 316. That is, the south pole of the first magnetic element 314 is positioned adjacent to the south pole of the second magnetic element 316. This not only releases the lock 302 by reducing or eliminating the attractive force, but may further encourage separation of the attached housing portions by way of magnetic repulsion.

The apparatus 300 may further include a spring 320 or other bias element connected to the first lock component 304 of the lock 302. The spring 320 connects the first lock component relative to the support 210 and first housing portion to provide a bias to movement of the first lock component 304. The spring 320 may bias the first lock component 304 and its first magnetic element 314, as shown in FIG. 3A, to selectively hold stationary the second housing portion relative to the first housing portion. The spring 320 may provide a return force that urges the first lock component 304 and its first magnetic element 314 to move to the locked position shown in FIG. 3A. The spring 320 may be selected to have a return force that is less than the force exerted by the shape-memory alloy wire 208 when heated, so that the unlocked position shown in FIG. 3B can be obtained against the return force. The spring 320 may thus encourage the lock 302 to return to the locked position of FIG. 3A when such position is intended, such as when the shape-memory alloy wire 208 is cooling.

In an example of operation, the magnetic lock 302 starts as locked, as shown in FIG. 3A. Motion of the second lock component 306 relative to the first lock component 304 is prevented or inhibited by magnetic attraction of the magnetic elements 314, 316. Current is then applied to the shape-memory alloy wire 208 and the shape-memory alloy wire 208 returns to its pre-deformed shape. This causes the shape-memory alloy wire 208 to pull the first lock component 304 away from the second lock component 306, in direction 322, against the bias provided by the spring 320 to shorten the distance between the first lock component 304 and the support 210, until the unlocked position shown in FIG. 3B is reached. With the magnetic elements 314, 316 now separated, the second lock component 306 may freely move as shown by arrow 324. In addition, the unlocked position may have the magnetic elements 314, 316 arranged to provide a repulsive force to encourage movement of the second lock component 306. When the magnetic lock 302 is to be re-locked, the current is stopped and the shape-memory alloy wire 208 cools and returns to its deformed shape, which may be assisted by the return force applied by the spring 320, allowing the distance between the first lock component 304 and the support 210 to lengthen until the locked position is reached, as shown in FIG. 3A.

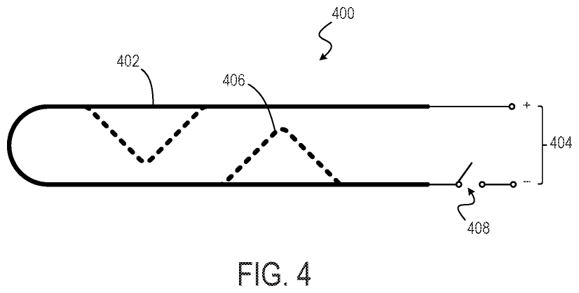

FIG. 4 shows an example circuit 400 with a shape-memory alloy element and a sensor to trigger the shape-memory alloy element to release a link or lock. The circuit 400 may be used with any of the links or locks discussed herein to control operation of the link or lock.

The circuit 400 includes a shape-memory alloy element 402 that may take the form of a wire that is looped or doubled-back on itself. A voltage 404 may be applied to the ends of the wire to trigger the pre-deformed shape 406 of the shape-memory alloy element 402. The voltage may be provided by a power source of the computing device that carries the circuit 400.

The circuit 400 further includes a sensor 408 (shown as a switch for convenience) in series with the wire-like shape-memory alloy element 402. The wire-like shape-memory alloy element 402 takes a shape responsive to the state of the sensor 408.

In this example, the circuit 400 applies current to the shape-memory alloy element 402, by way of the voltage 404, in response to the sensor 408 completing the circuit 400. When the sensor 408 is activated (e.g., the switch is closed), the circuit 400 is completed and the voltage 404 causes a current to flow through the shape-memory alloy element 402. The shape-memory alloy element 402 heats and takes its pre-deformed shape 406. When the sensor 408 is deactivated (e.g., the switch is open), the circuit 400 is broken and the shape-memory alloy element 402 cools and returns to its deformed shape.

The sensor 408 may include a Hall effect sensor, a mechanical switch, an accelerometer, a potentiometer, a tilt switch, a user-actuatable button, or similar device that selectively causes the current to flow. A Hall effect sensor may measure an angle of a housing portion relative to a magnetic field that may be produced by a magnetic element located at another component. Such a Hall effect sensor may be configured to complete the circuit 400 when a specific angle is detected. A Hall effect sensor may be positioned relative to a permanent magnet to complete the circuit 400 based on a relative position of a second housing portion to a first housing portion, in which one of the housing portions carries the Hall effect sensor and the other carries the permanent magnet. When the housing portions are relatively moved into a particular configuration, the Hall effect sensor detects a particular field provided by the permanent magnet and closes the circuit 400. A similar result may be achieved with a sensor 408 in the form of pogo pins. In other examples, the sensor 408 takes the form of a user-actuatable button and thus the user has direct control over the link or lock.

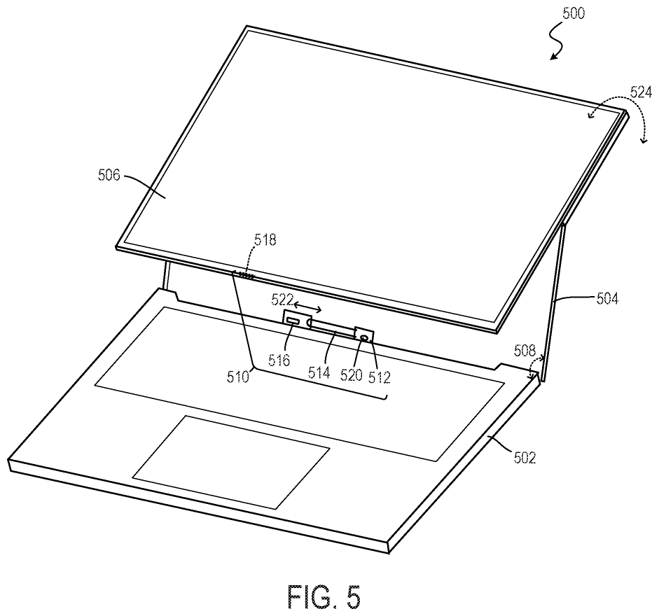

FIG. 5 shows an example computing device 500 with a shape-memory alloy element to release a link to allow relative motion of housing portions of the computing device.

The computing device 500 includes a base housing portion 502, a first housing portion 504, and a second housing portion 506.

The base housing portion 502 may contain a processor, memory, keyboard, trackpad, and other components of the computing device 500.

The first housing portion 504 is hinge connected to the base housing portion 502 and may be termed an arm. The first housing portion 504 is pivotable with respect to the base housing portion 502 at an angle 508.

The second housing portion 506 is hinge connected to the first housing portion 504 and is pivotable with respect to the first housing portion 504, as indicated by arrow 524. The second housing portion 506 may be termed a display panel. The second housing portion 506 may include a display device, such as a light-emitting diode (LED) or liquid-crystal display (LCD) touchscreen.

The computing device 500 includes a link apparatus 510 to selectively lock the second housing portion 506 to the first housing portion 504 to inhibit or prevent the relative rotation indicated by arrow 524.

The link apparatus 510 includes a support 512, shape-memory alloy wire 514, first magnetic element 516, second magnetic element 518, and sensor 520.

The support 512 is attached to the first housing portion 504 or may be formed with the first housing portion 504.

The shape-memory alloy wire 514 is attached to the support 512. The shape-memory alloy wire 514 may have deformed and pre-deformed shapes, as discussed elsewhere herein. The shape-memory alloy wire 514 and related component may be installed inside the first housing portion 504, which may take the form of a flat panel. Accordingly, the curvature of the shape-memory alloy wire 514, in both its deformed and pre-deformed shapes, may reside within a plane, so that the shape-memory alloy wire 514 readily fits within the flat first housing portion 504.

The first magnetic element 516 is attached to the shape-memory alloy wire 514 at a position opposite the support 512. The first magnetic element 516 is slidable along an axis 522 with respect to the first housing portion 504 in response to action of the shape-memory alloy wire 514.

The second magnetic element 518 is attached to the second housing portion 506.

When the shape-memory alloy wire 514 is in its deformed shape, the first magnetic element 516 is aligned with the second magnetic element 518, such that the second magnetic element 518 is attracted to first magnetic element 516 to hold the second housing portion 506 stationary with respect to the first housing portion 504. FIG. 3A shows a comparable locked position of comparable magnetic elements 314, 316.

When the shape-memory alloy wire 514 is in its pre-deformed shape, the first magnetic element 516 is moved to be misaligned with the second magnetic element 518, such that the second magnetic element 518 is less attracted or not significantly attracted to first magnetic element 516. The second housing portion 506 is then free to rotate relative to the first housing portion 504, as indicated by arrow 524. FIG. 3B shows a comparable unlocked position of comparable magnetic elements 314, 316.

The sensor 520 may detect the position of the first housing portion 504 and control the shape-memory alloy wire 514 accordingly. In this example, detecting the position of the first housing portion 504 includes detecting the angle 508 of the first housing portion 504 with respect to the base housing portion 502. As such, the sensor 520 may be a Hall effect sensor, accelerometer, or similar device capable of detecting an angle. Using a suitable angle 508 to unlock the link apparatus 510 may prevent inadvertent rotation of the second housing portion 506 when the first housing portion 504 is not at a suitable orientation. In other words, the link apparatus 510 may be controlled with respect to the angle 508 to permit rotation of the second housing portion 506 when the first housing portion 504 is oriented at an angle 508 that is compatible with such rotation.

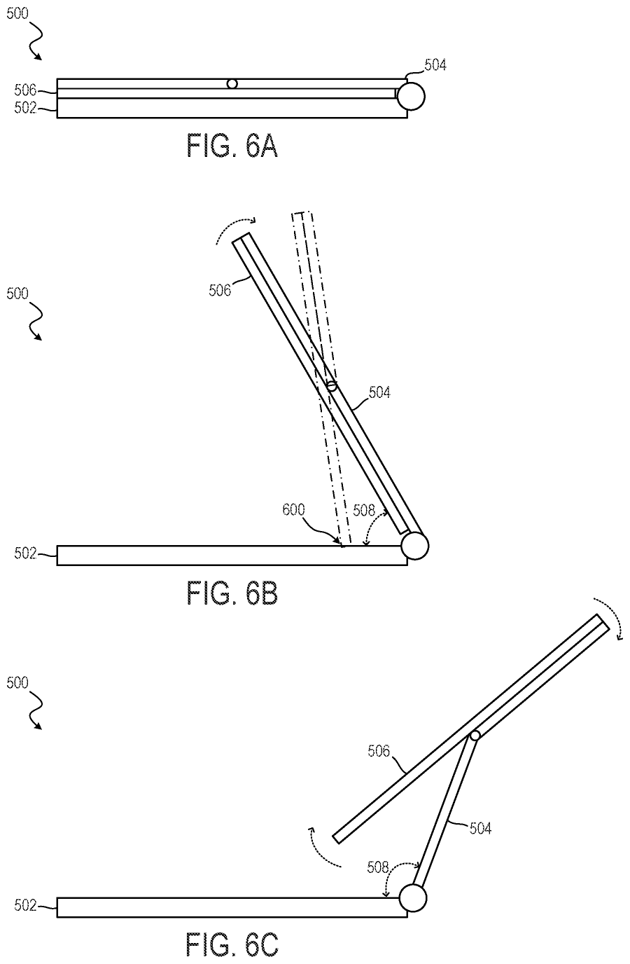

FIGS. 6A-6C show the computing device 500 from the side to illustrate the sensor 520 controlling the shape-memory alloy wire 514 based on the angle 508 of the first housing portion 504. In FIG. 6A, the computing device 500 is closed and the second housing portion 506 or display panel is abutted against the base housing portion 502. In FIG. 6B, the user has started to open the computing device 500 by lifting the second housing portion 506. The link apparatus 510 holds the second housing portion 506 to the first housing portion 504, which is pivot connected to the base housing portion 502. As such, the first and second housing portions 504, 506 rotate in unison as angle 508 increases. When the angle 508 reaches a predetermined angle, such as 120 degrees, the sensor 520 causes the shape-memory alloy wire 514 to take its pre-deformed shape and separate the magnetic elements 516, 518, so that the link apparatus 510 no longer holds the second housing portion 506 to the first housing portion 504. The second housing portion 506 is thus free to rotate with respect to the first housing portion 504. For example, the second housing portion 506 may be rotated fully to the other side of the first housing portion 504, so that the computing device 500 may be closed with to the display aimed outwards in what may be termed a tablet mode.

With reference to FIG. 6B, without the link apparatus 510, force applied by the user to manually open the second housing portion 506 may cause the second housing portion 506 to prematurely disengage from the first housing portion 504 and strike the base housing portion 502 at 600, potentially causing damage.

The angle 508 at which the sensor 520 triggers the shape-memory alloy wire 514 to unlock the link apparatus 510 may be predetermined based on the geometry and intended operation of the specific implementation of the computing device 500. A predetermined angle of 120 degrees is merely an illustrative example.

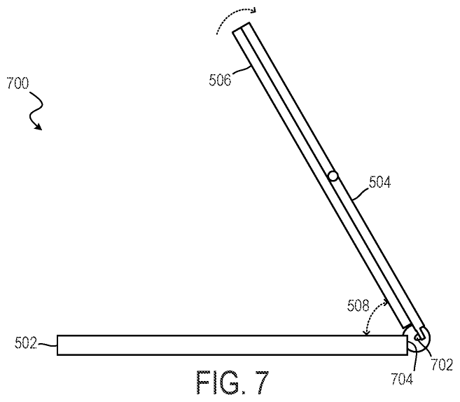

FIG. 7 shows an example computing device 700 with a switch 702 to activate a shape-memory alloy element. FIGS. 5 and 6A-6C may be referenced for detail not repeated here.

The switch 702 may be used as the sensor described in the other examples discussed herein. The switch 702 may be attached to a first housing portion 504 and may be positioned and oriented to close when in contact with the base housing portion 502, at 704. Closing the switch provides current to a shape-memory alloy element that, in response, disengages a link or lock that secures a second housing portion 506 to the first housing portion 504. An angle 508 at which the switch 702 closes may be predetermined by selecting the position and orientation of the switch 702 as well as other geometry of the computing device 700. The switch 702 may include a microswitch. The switch 702 may include a pair of pogo pins that contact a conductive trace positioned at 704 to complete the circuit.

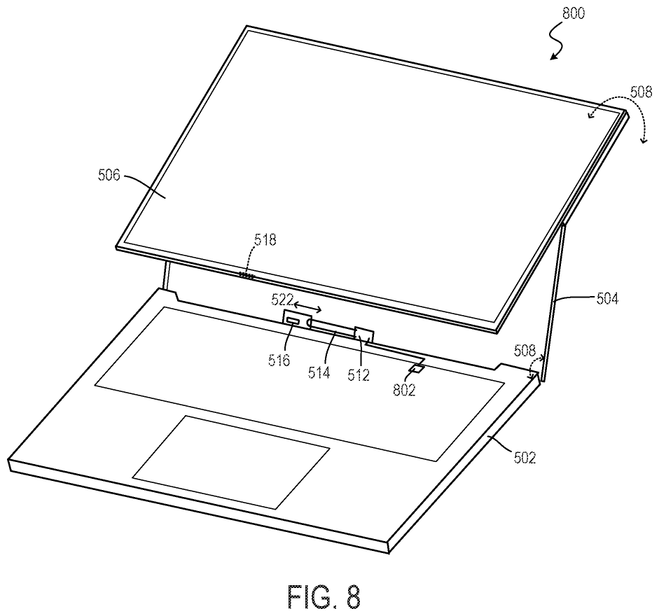

FIG. 8 shows an example computing device 800 with a user-actuatable button 802 to activate a shape-memory alloy element. FIGS. 5 and 6A-6C may be referenced for detail not repeated here.

The button 802 may be used as the sensor described in the other examples discussed herein. Pressing the button 802 provides current to a shape-memory alloy element 514 that, in response, disengages a link or lock that secures a second housing portion 506 to a first housing portion 504. The button 802 may be a toggle that alternatively switches current on and off or may be held to provide the current. The button 802 may be a keyboard key or another button located at or near the keyboard of the computing device 800. A user may press the button 802 to control the link or lock as desired.

In view of the above, it should be apparent that a shape-memory alloy element may be used to control a link, such as a magnetic element, to allow a housing to move or be reconfigured. The shape-memory alloy may deliver a relatively low amount of force to actuate the link, which may bear a relatively higher amount of force. As such, shape-memory alloy may be leveraged to control the positioning or movement of a housing of the computing device.

It should be recognized that features and aspects of the various examples provided above can be combined into further examples that also fall within the scope of the present disclosure. In addition, the figures are not to scale and may have size and shape exaggerated for illustrative purposes.

1. A computing device comprising:
a first housing portion;
a second housing portion moveably connected to the first housing portion;
a link to selectively secure the second housing portion to the first housing portion to inhibit movement of the second housing portion relative to the first housing portion; and
a shape-memory alloy element to release the link to allow the second housing portion to move relative to the first housing portion.

2. The computing device of claim 1, wherein the shape-memory alloy element comprises:
a deformed shape that urges the link to secure the second housing portion to inhibit movement of the second housing portion; and
a pre-deformed shape that releases the link when the shape-memory alloy element is heated.

3. The computing device of claim 1, wherein the shape-memory alloy element comprises a shape-memory alloy wire.

4. The computing device of claim 3, wherein the shape-memory alloy wire comprises a pre-deformed shape that includes a bend that is shaped to release the link.

5. The computing device of claim 3, wherein the shape-memory alloy wire comprises a pre-deformed shape that includes curvature within a plane, where the curvature is shaped to release the link.

6. The computing device of claim 3, wherein the shape-memory alloy wire comprises a pre-deformed shape that includes a loop.

7. The computing device of claim 1, further comprising a bias element to urge the link to engage to prevent the second housing portion from moving relative to the first housing portion.

8. An apparatus comprising:
a first housing portion;
a second housing portion moveably connected to the first housing portion;
a lock to selectively hold stationary the second housing portion relative to the first housing portion when locked; and
a shape-memory alloy wire connected to the lock, the shape-memory alloy wire including a pre-deformed shape to unlock the lock when current is applied to the shape-memory alloy wire.

9. The apparatus of claim 8, wherein the lock comprises:
a first magnetic element attached to the first housing portion; and
a second magnetic element attached to the second housing portion.
wherein the first magnetic element and the second magnetic element are arranged in an attractive relative positioning to hold stationary the second housing portion relative to the first housing portion; and
wherein the shape-memory alloy wire is connected to the first magnetic element to selectively move the first magnetic element away from the attractive relative positioning when the current is applied to the shape-memory alloy wire.

10. The apparatus of claim 9, wherein the first magnetic element or the second magnetic element comprises a permanent magnet.

11. The apparatus of claim 8, further comprising a spring connected to the lock, the spring to bias the lock to selectively hold stationary the second housing portion relative to the first housing portion.

12. The apparatus of claim 8, further comprising
a sensor; and
a circuit including the sensor and the shape-memory alloy wire, wherein the circuit is to apply the current to the shape-memory alloy wire in response to operation of the sensor.

13. The apparatus of claim 12, wherein the sensor comprises a Hall effect sensor or a switch to cause the current based on a relative position of the second housing portion to the first housing portion.

14. The apparatus of claim 12, wherein the sensor comprises a user-actuatable button to cause the current.

15. A device comprising:
a sensor to detect a position of a first component of a computing device;
a link to selectively secure a second component of the computing device to the first component to inhibit movement of the second component relative to the first component; and
a shape-memory alloy element electrically connected to the sensor and mechanically connectable between the link and the first component of the computing device, wherein the shape-memory alloy element is responsive to the sensor to control the link to free the movement of the second component relative to the first component.

16. The device of claim 15, wherein the sensor comprises a Hall effect sensor.

17. The device of claim 15, wherein the sensor comprises a mechanical switch.

18. The device of claim 15, wherein the shape-memory alloy element includes a pre-deformed shape and a deformed shape, wherein the pre-deformed shape provides a distance that is shorter than a distance provided by a deformed shape.

19. The device of claim 15, further comprising a bias element to bias the link to inhibit the movement of the second component relative to the first component, wherein the shape-memory alloy element is operable against the bias element to control the link to free the movement of the second component relative to the first component.

20. The device of claim 15, wherein the link comprises a magnetic element.
